(19) United States
(12) Patent Application Publication
(10) Pub. No.: US 2012/0173351 A1
(43) Pub. Date: Jul. 5, 2012

(54) Mobile Electronic Shopping

(75) Inventors: David Jaray Hanson, Maple Valley, WA (US); Harshad Narayan Kamat, Sammamish, WA (US); Dawnie Joan Moss, Seattle, WA (US); Aaron Brian Roberts, Monroe, WA (US); Sarinder Virk, Issaquah, WA (US)

(73) Assignee: QTHRU, LLC, Monroe, WA (US)

(21) Appl. No.: 13/340,503

(22) Filed: Dec. 29, 2011

Related U.S. Application Data
(60) Provisional application No. 61/428,158, filed on Dec. 29, 2010.

(51) Int. Cl. G06Q 20/20; G06Q 30/06; G06Q 20/32

(52) U.S. Cl. 705/17; 705/26.81

(57) ABSTRACT

The present disclosure describes electronic shopping systems, specifically electronic shopping and payment embodiments, which utilize a software program running on a device to digitally photograph a machine-readable representation of data including but not limited to a UPC, a digital photograph of a product or product identification code, a voice representation of a product or product identification code, or the manual entry of a product identification code to identify products which are then stored on a client or server in a virtual shopping cart. Virtual shopping cart items are purchased through an electronic payment system from the mobile device using a client and server. The physical representation of these items may be located in an actual shopping cart in a brick and mortar store or virtually located through the Internet.

### RELATED APPLICATIONS

This application claims priority to provisional application “Mobile Electronic Shopping” with Ser. No. 61/428,158, filed Dec. 29, 2010 which is incorporated herein in its entirety.

### BACKGROUND

Electronic shopping systems have become popular because they increase convenience to customers while decreasing costs to vendors. As society has come to expect mobile connectivity to information and to shopping experiences, it is desirable to conduct shopping from anywhere at any time, whether the products are tangible or virtual.

Some electronic shopping systems are used so that customers are not required to travel to a store. An example of this type of electronic shopping system would be an Internet website which allows shoppers to purchase books and videos from the comfort of their home or a coffee shop. Usually payment is made when a customer provides a credit card number or bank account information. Products are usually shipped to the customer.

However, shoppers must often provide access to a sensitive data such as credit card or bank account information to participate in this type of shopping system. Once this data is entered, it is often stored in multiple vendors' databases along with a shopper's account information and possibly the shopper's physical address.

Another type of electronic shopping system is kiosk based self-checkout. These types of systems provide a cost savings to vendors, and some implied convenience to shoppers. One station of four kiosk based self-checkout systems managed by one employee can replace four full checkout systems managed by four employees. Kiosk based self-checkout systems have become ubiquitous, and shoppers use computerized kiosks to scan barcodes, weigh products, and apply coupons to purchase goods.

However, present kiosk based self-checkout systems may have high equipment costs. Specifically, the kiosks incorporate scanners as part of the kiosk based self-checkout system, and so vendors must incur the expenses of the scanners as well as the kiosk interface to the self-checkout software. Furthermore, the scanners are only used for the store in which they are installed.

All the aforementioned shopping mechanisms using electronic payments are unable to provide a single unified payment abstraction layer. Accordingly, direct access to a credit card number or physical access to a credit card must usually be provided, decreasing shopper security.

### SUMMARY

The present disclosure describes mobile electronic shopping. Specifically, the present disclosure describes an electronic shopping system for facilitating purchase transactions managed by the shopper from a client to which a program download function, a program execution function, a product or transaction recognition function, and a payment function have been added. However, since the functionality added to the wireless device is incremental, the wireless device is still capable of being produced inexpensively while being purchased by shoppers and not vendors.

Mobile electronic shopping may comprise one or more servers and one or more clients for communicating with the server. The one or more servers may host a fulfillment system, and potentially an inventory system. There may be one mobile electronic shopping server hosting a fulfillment system per store, or multiple stores may interface with a single mobile electronic shopping server installation hosting a fulfillment system. In this embodiment, stores will identify themselves to the fulfillment system via a location or store identifier.

In the present disclosure, once a customer visits a store, the customer executes a mobile shopping application on a wireless client. A digital camera, located on the wireless client may be used to recognize the bar codes of purchased items or the items themselves through pattern recognition, or item codes are manually entered or spoken, or the product name is spoken. Thus, the embodiments in the present disclosure allow retailers to implement a personal shopping system while minimizing the cost investment to do so. A store server may be a dedicated server running within a retail store, within a hosted data center, within a virtualized cloud server, or within a data grid.

Furthermore, a retailer maintains a server, which may host an inventory system, which may provide product identification codes, descriptions, images, and pricing information to the shopping system servers. The mobile electronic shopping servers communicate with the wireless device to maintain a virtual shopping cart with product identification codes, descriptions, images, and pricing information. Specifically, the mobile shopping application on the wireless device will communicate with the fulfillment system on the mobile electronic shopping servers. The virtual shopping cart, in the fulfillment system, will maintain the shopping items in association with a downloaded application or wireless device in the event a wireless device loses signal connectivity or battery.

It may be desirable for retailers to have a “branded” version of the downloaded application so that the application maintains the retailer's trademark art, colors, and marketing materials. As such the application would have all the elements available to ensure the customer feels as if the retailer has created the application.

Further, since different wireless devices have different displays, cameras, keyboards, touch screen interfaces, and/or graphical user interfaces, it would be desirable to have different versions of the same program available for download. Further, as used herein, the use of the term “download” is defined as the process of storing compiled software code in non-volatile memory, hard disk, or other storage medium, which retains stored information even when not powered by the wireless device.

Although the mobile electronic shopping embodiments as presently disclosed are described herein as being used to purchase products, those skilled in the art will appreciate that mobile electronic shopping is likewise suitable for purchasing services, or anything else, which is desired. Thus, use of the term “product” is by way of illustration only and not by way of limitation. Further, as used herein the term “store” is defined to include any seller of goods or services, including a retail store, wholesale store, or any other vendor, including those remotely offering products through the Internet.

For the specific scenario of a customer with a wireless device making purchases in a bricks and mortar store on the premises, the store will be referred to as a local store. Thus we may describe a customer shopping in a physical store, browsing physical products in the physical store's aisles, and then checking out products for purchase in the physical store's point of sale system as a customer shopping in a local store.

The downloaded program, when run from the wireless device communicates with the mobile electronic shopping server using a an Internet based protocol running over a cellular phone provider's network, a satellite wireless network, a WiFi wireless network, or the retailer's wireless network.

Pursuant to the mobile electronic shopping process, collection of payment may be necessary before purchase can be completed. In the present disclosure payment may be collected from the mobile electronic shopping server before purchase is completed. Payment information may be stored on the mobile electronic shopping servers. Payment information may be gathered from the wireless device through a secure communication channel, or placed directly on the mobile electronic shopping servers by an automated or batch process. Payment information may be protected on the mobile electronic shopping servers through encryption. An authorization code, password, token, device or user identity, or biometric data reading may be used to protect access to the process of payment using a wireless device. Alternatively, payment information may be stored in a third party payment system or payment aggregation service.

Further to the purchase of products, anyone skilled in the art would recognize the desire to offer other services such as coupon discounting, shopping lists, product information, product suggestions, and price comparison.

Further to the purchase of products, anyone skilled in the art would recognize the desire to offer the ability to abstract customer data collection to the wireless payment server such that a shopper could purchase a product remotely over the Internet without having to provide extraneous details such as email shopper name, email address, physical address, shipping address, or payment method.

Additionally, for retailers offering tangible products at a physical location, it may desirable to receive an immediate payment confirmation that products have been purchased before the shopper leaves the facility. Anyone skilled in the art would appreciate the desire to provide a software program which could determine when the completion of payment occurred. This could include a desktop computer running a program or a wireless device running a program. It would also be desirable to provide a printed receipt to replicate the regular buying process already used by stores. Further, a receipt printout might be created by associating a receipt printer with a machine-readable code, thus allowing the direction of said receipt to the correct receipt printer when a shopping transaction was completed. Additionally, a reference number printed on the receipt could match a reference number provided in a computer program provided to a store or retailer.

Further to payment, anyone skilled in the art would appreciate the desire to secure payment transactions by adding the ability to input a personal identification number or password before completing a transaction. Anyone skilled in the art would also recognize the desire to utilize a personal identification number or password to secure and protect changes to payment settings such as payment type, shipping address, billing address, or any other account data.

The embodiments in this disclosure also facilitate the completion of payment through a unique transaction identity. The transaction identity could be an immutable identity within the payment domain. This identity could exist until it expires or is used by the system, whichever occurs first, at which point it could be reused again. Transaction identities could be a unique number, a combination of letters and numbers, a universal resource locator, or a universal resource identifier. From an implementation standpoint a transaction identify could be referenced by machine-readable codes of varying symbology such as UPC for numbers or Code 39 for letters and numbers, where URLs or URIs could be represented by a 2D barcode such as QR Code.

Transactions could be facilitated by a World Wide Web based protocol such as http to create and retrieve shopping items. Shopping items could be stored through a “post” to a web server, while retrieving shopping lists could be through a “get” request.

Additionally, it would be desirable for stores and customers to be able to return items after transactions have completed in the event an item were damaged or not desired. A return could be conducted through the downloaded program before returning an item to a store. This would streamline the return process, ensuring the item was purchased through the customer; assist the store in gathering customer data for the return and help in determining the reason for the return. Standing in line for a return may be paperless and simple. This type of transaction could be facilitated through a “post” to a web server.

Thus, the present disclosure describes a convenient method for electronic shopping, either while at a store, at a kiosk, in a drive through, anywhere goods are sold, or while away from a store when shopping on the Internet.

It would be desirable to have a direct or representative product data by which information such as prices, quantities, stock-keeping unit numbers, product lookup codes, universal product identification codes, storage location, item description, or other data about relevant products can be retrieved in real-time.

Additionally, it would be desirable to aggregate external data relevant to the shopping experience such as pricing comparisons, social media, ratings or reviews, nutritional information, and product specifications. It may also be desirable to quickly locate items within the store for a faster shopping using data store specific data pulled from in-store shopping servers. This data could direct a shopper to a specific aisle and shelf to find a product.

It would be desirable to provide an external programmatic Application Programmatic Interface (API) for third parties and retailers so that they could craft a shopping experience specific to their needs or acquire information specific to their shopper's data for analytical or accounting purposes.

Retail establishment customers might benefit from real time shopping analytics and reporting to better understand how their customers shop within their store or use their service.

To facilitate a secure transaction, a programmatic interface on the wireless device might provide a security protected personal identification number or code which could prevent the completion of the payment process in the event the customer's wireless device is lost or stolen. Additionally, the wireless device might use a biometric mechanism such as fingerprint, pheromone sensing, or optical recognition system to identify the device and account owner. Additionally, payment card data may be abstracted from the wireless device and stored remotely on secured servers for future payment processing.

It might also be beneficial to retail customers to purchase an item in the retail store without taking that item with them when exiting the establishment. Instead the item could be shipped to a destination using a different method of fulfillment. For example, this might be beneficial for purchasing a gift for someone in a remote location, or when the desired size or color is not available.

It may also be beneficial to retail customers to provide ties to social media so that a shopper could purchase the same items their favorite sports hero purchases, or see what a friend or loved one purchases.

Additionally, it may be desirable for a retail customer to purchase bulk products such as fruits, vegetables, and other items that must be weighed before purchase. It may be desirable to use an electronic scale that accesses product data from in-store servers. The scale, when provided a product lookup code, a UPC, or other product identifier code may then in return provide a machine-readable representation of data, which is decodable by a wireless device. Once the wireless device has captured the barcode, a product reference to the bulk item, fruit, or vegetable is associated with that product and its price, which is then added to the virtual shopping cart. The electronic scale may be used with or without the shopping system and could be placed in close proximity to bulk items, fruits, vegetables, or other items which must be weighed.

### BRIEF DESCRIPTION OF THE DRAWINGS

The Detailed Description is set forth with reference to the accompanying figures. In the figures, the left-most digit(s) of a reference use of the same reference numbers in different figures indicates similar or identical items.

FIG. 1 is a schematic overview of the electronic shopping embodiments.

FIG. 2 is a functional diagram depicting methods of product identification for the electronic shopping embodiments.

FIG. 3 is a block diagram depicting an embodiment of a fulfillment system and environment.

FIG. 4 is a flow chart depicting an embodiment of a fulfillment system.

FIG. 5 is a flow chart depicting an embodiment of performing analytic reports for customers from transaction data stored by the fulfillment system.

FIG. 6 is a block diagram depicting the method of an in-store checkout where the completion of transactions occurs.

FIG. 7 is a flow chart of an exemplary wireless device operation.

FIG. 8 is a flowchart showing the steps in using the program and electronic payment service in a brick and mortar store and completing a transaction.

FIG. 9 is a block diagram depiction of a brick and mortar store embodiment.

FIG. 10 is a block diagram depiction of a drive through establishment embodiment.

FIG. 11 is a block diagram depiction of a retail store embodiment with kiosk-based ordering.

FIG. 12 is a block diagram depiction of a laptop computer Internet shopping embodiment.

FIG. 13 is a block diagram depiction of restaurant purchase embodiment.

FIG. 14 is a block diagram depiction of a vending machine embodiment.

FIG. 15 is a block diagram depiction of a pricing and product lookup scale embodiment.

FIG. 16 is a depiction of potential machine-readable codes, potentially utilized by the embodiments disclosed herein.

FIG. 17 is a flowchart of an exemplary operation of a mobile electronic shopping client.

FIG. 18 is a flowchart of an exemplary operation of a mobile electronic shopping server.

### DETAILED DESCRIPTION

### Overview and Platform Introduction

The present disclosure describes mobile electronic shopping. Mobile electronic shopping is typified by the ability to make use of mobile wireless devices, in particular mobile wireless devices that communicate wirelessly, to interface with physical objects, discover information about those physical objects, pay for those objects via a transaction, and effect fulfillment of the transaction. Additionally, the present disclosure includes aggregating, mining, and packaging data from mobile electronic shopping transactions, and extending mobile electronic shopping via peripheral devices, including, but not limited to digital scales and third party point of sale systems.

Presently, customers may carry a wireless device which enables mobile shopping. As used herein, the term wireless device is defined to include personal cellular phone, smart-phone, satellite phone, Wi-Fi phone or device, net-book, mobile tablet, or any other mobile appliance capable of wireless communications. Wireless devices generally comprise a process, a memory, logic resident on the memory to perform wireless communications functions, and a communications interface. The logic resident on the memory, may include an operating system, and a mobile electronics shopping application. Wireless communications may include 3G, 4G cellular protocol support, or Wi-Fi or other packet based protocol support. With mobile electronic shopping, a customer may make purchases at any time, from any location, for any type of product.

Similarly, stores may operate a mobile electronic shopping fulfillment system resident on a server. A server may comprise a processor, a memory, logic resident in the memory for a mobile electronic shopping fulfillment system, and a network interface. The logic resident in memory may include an operating system, a database management system, the fulfillment system, and other databases such as an inventory system.

For both a wireless device and for a server, memory includes both short term and long term memory and may host the unified notification platform. Examples of short term memory include static random access memory (“SRAM”) and dynamic random access memory (“DRAM”). Examples of long term memory include programmable read only memory (“PROM”) and hard disks.

Both short and long term memory both on-board and removable computer-readable media. Computer-readable media includes, at least, two types of computer-readable media, namely computer storage media and communications media.

Computer storage media includes volatile and non-volatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (“DVD”) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

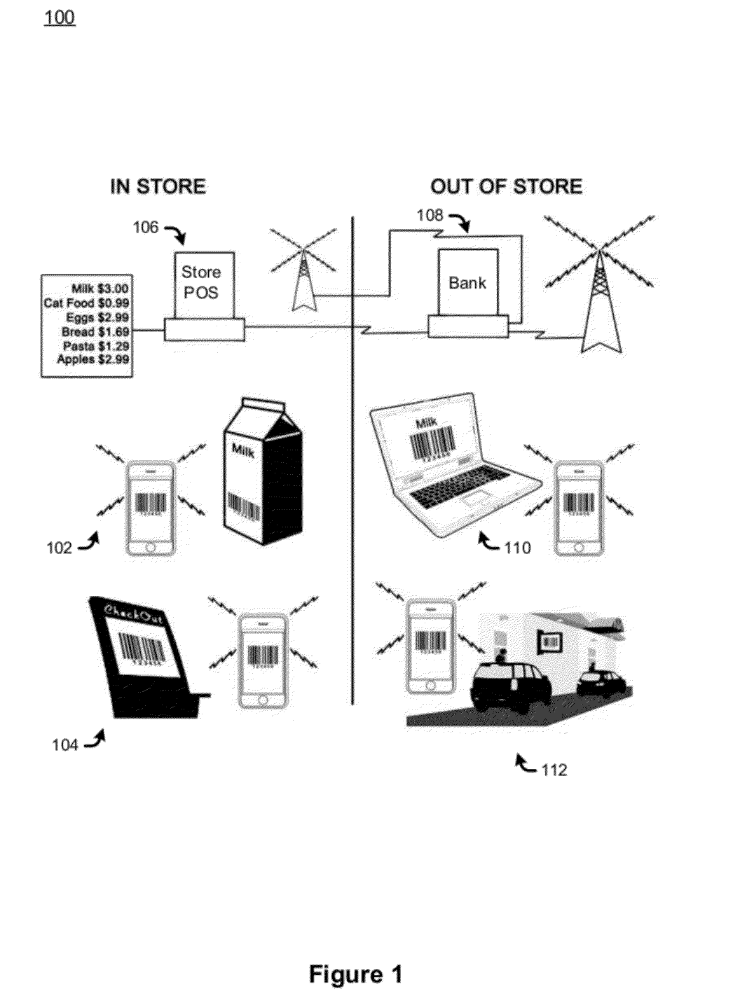

FIG. 1 illustrates an overview schematic 100 for mobile electronic shopping. A user with a mobile wireless device could perform shopping operations both in store, such as a brick and mortar store, and out of store.

Exemplary in store operation may include scanning a product via bar code 102, or entering a product identification code manually into a wireless device (not shown). The wireless device could then transmit data to a check-out kiosk 104 to effect payment. The kiosk might then interface with a point of sale system (“POS”) 106 and perform debits and credits on the user's account at a bank 108 or other financial institution. An example might be to debit a bank account via the user's debit card account number. Another example might be to debit a gift card as issued by a vendor. In effect, mobile electronic shopping enables self-checkout, but with the scanning done while shopping, not at the time of checkout.

Product identifier codes are product identification numbers encoded in scannable form. A product identification number is a number that uniquely identifies a stockable item in a store, such as a UPC number. Product identification numbers are typically encoded in bar codes including UPC one-dimensional bar codes and QR codes. Product identifier codes are not limited to storing product identification numbers. For example, QR codes may store information about the product that the vendor wishes to communicate to a customer, or may embed web addresses to web sites containing product information.

Mobile electronic shopping enables shopping regardless of location. Exemplary out of store operations may include effecting payment for on-line transactions via a wireless device. Interfacing may be in the form of scanning a bar code displayed on a computer screen 106, or alternatively via WiFi or infrared wireless communications between a computer and the wireless device (not shown). Other transactions may include payment at drive through windows via scanning bar codes on an external screen 108, or otherwise via wireless communications (not shown).

### Exemplary Input Operation

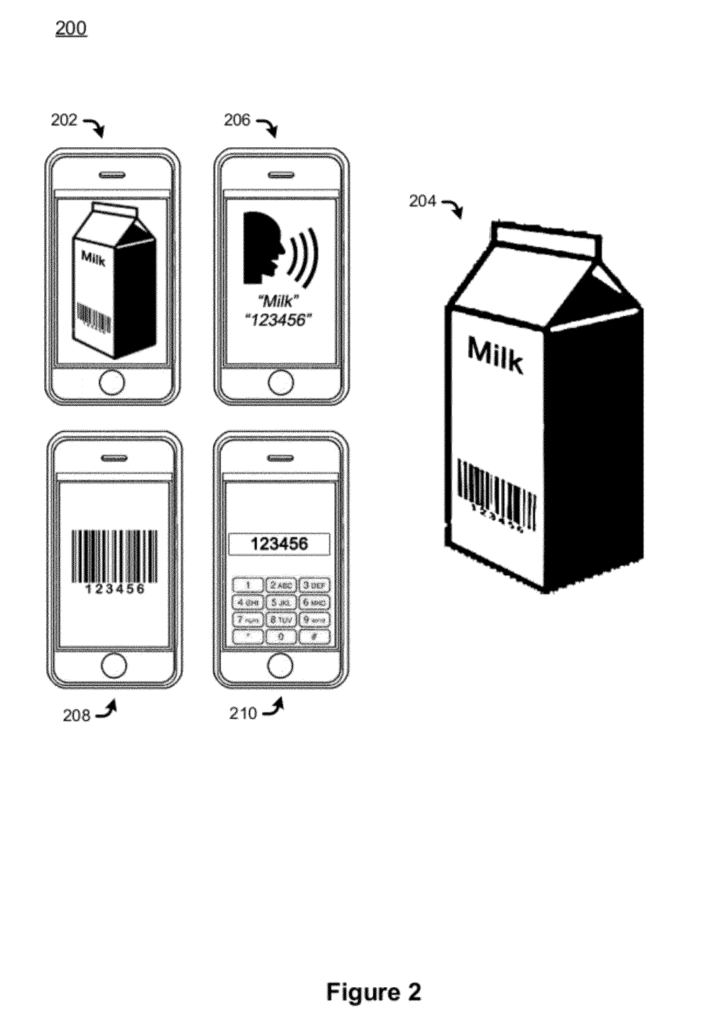

In mobile electronic shopping, the wireless device can perform the role of an input device to interface with products and other artifacts in the real world. FIG. 2 illustrates various exemplary methods 200 of inputting product identification information into a wireless device. Automated entry examples include object recognition after taking a picture 202 of a product 204; or alternatively using the wireless device's camera to scan a product identification code 206 such as a bar code or other identification coding scheme. Examples of manual entry may include voice entry of a product identification code 208, such as a UPC code; or entry of the product identification code via keypad or touch screen 210.

The wireless device may be modified to support other forms of product tagging. For example, the wireless device may incorporate a radio frequency identification (“RFID”) tag reader. Alternatively, the wireless device may be modified to support near field communication (“NFC”). For example, products may transmit product information via near field magnetic induction (“NFMI”) to limit transmittal distance and to provide secure communications in a power efficient fashion.

In general, the wireless device provides more secure payment than active smartcards. Where active smartcards continuously transmit information, identity theft may perpetrated simply by scanning an unaware user. In contrast, the wireless device does not transmit information or perform purchases unless the user has specifically made a notification to purchase.

### Exemplary Server Side Embodiment

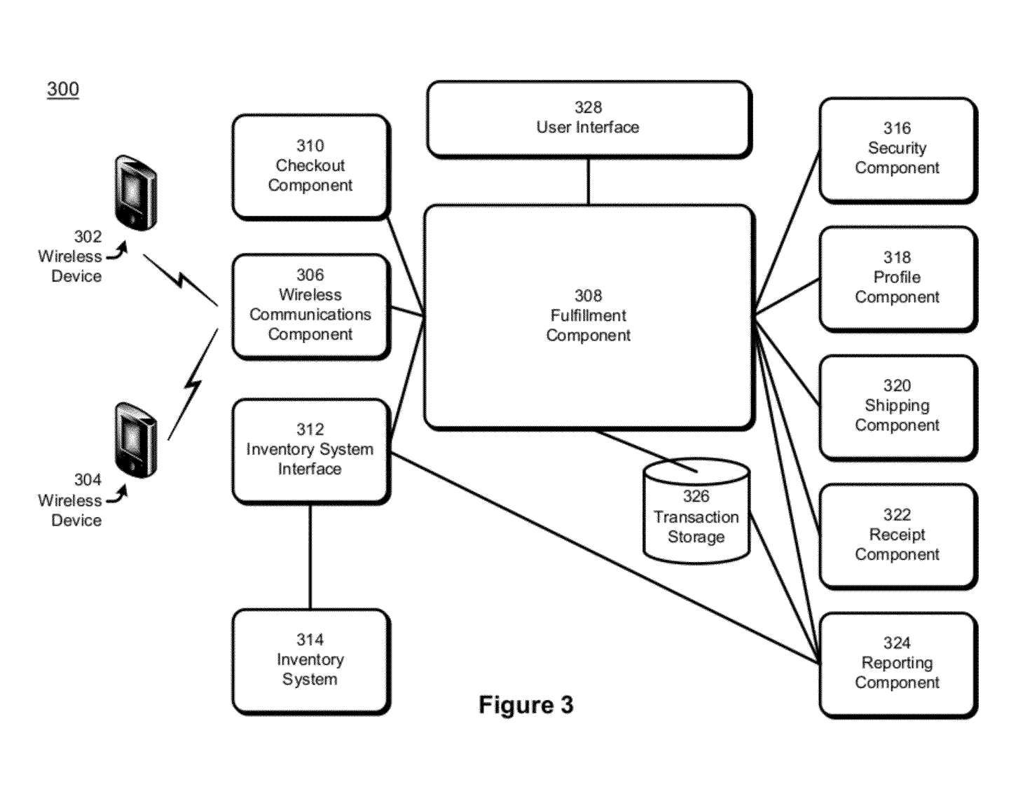

In mobile electronic shopping, the wireless device can perform purchases by interfacing with a fulfillment system usually on a server, which provides interfaces with a point of sale system and the customer's funds. FIG. 3 illustrates one embodiment 300 of a fulfillment system and its environment.

Wireless devices 302 and 304 communicate via a wireless communications component 306. The wireless communications component 306 recognizes one or more wireless protocols in order to interface with a heterogeneous set of wireless devices 302 and 304. For example, wireless device 302 may communicate via Bluetooth and wireless device 304 may communicate via Wi-Fi. Unlike prior art kiosks which can demand a particular protocol, the wireless communications component supports a wide range of protocols in order to support communications with a corresponding wide range of wireless devices.

Furthermore, the wireless communications component 308 segregates communications between the various wireless devices 302 and 304 into separate secure sessions.

Communications between wireless devices 302 and 304 and wireless communications component 306 need not be proximate. For example, some communications may occur via 3G or Wi-Fi when the customer is browsing products in an aisle in a store, and communications may occur via Bluetooth or IRDA when the customer is next to a checkout kiosk.

Alternatively, fulfillment system and environment 300 may include non-wireless communications components which may include keyboards, touchscreens, displays, and receipt printers.

Wireless communications component may then transmit messages to a fulfillment component 308. Fulfillment component 308 satisfies requests and other communications from wireless devices 302 and 304 embodied in messages from the wireless communications component 306. Messages may include a scanned product identification code requesting product and other related information. Other messages may be an order comprising a product identification code and a number of items to purchase. Yet other messages may be a purchase indicator, to effect payment.

Fulfillment component 308 satisfies requests embodied in messages by invoking various other components as follows.

Fulfillment component 308 may maintain a virtual shopping cart for a customer. Specifically, for each customer, the fulfillment component may receive order requests and may store product identifier codes and item counts of products ordered.

Fulfillment component 308 may communicate with a checkout component 310 which provides an interface to a customer's financial institution. Communications may include debiting a customer's financial account to make purchases and crediting a customer's financial account to make returns. An example financial account would be to debit a customer's credit card.

Note that financial accounts need not be of money per se. For example, some companies issues electronic scrip or electronic points that represent monetary value, but are not issued by governments. For example, online poker chips, and online points for various massively multiplayer online role playing games (“MMORPG”) are used as money within limited Internet sites, but are not government currency. Checkout component 310 may interface with those Internet sites and support such electronic scrip.

Fulfillment component 308 may communicate with an inventory system interface 312. The inventory system interface 312 provides an interface to a store's inventory system 314. The inventory system 314 may be resident in store, or available over an enterprise network, or available in the Internet cloud. In some instances, the store's inventory system 314 may be a third party inventory system offered as a web service. Alternatively, the store's inventory system 314 may be part of a global inventory system across multiple stores, and potentially multiple companies.

Fulfillment component 308 may communicate with security component 316. Specifically, prior to any customer account being accessed, the request may be validated. By the security component 316. If the security component 316 authenticates the request, the fulfillment component 308 may invoke account debits and credits via the checkout component 310. In one embodiment, the fulfillment component 308 may receive a message with a purchase indicator. The message may also include customer identity information such as an account number and a password. The fulfillment component 308 may validate the account number and password with the security component 316. Only if the security component 316 validates the account and accordingly the message, would the fulfillment component 308 invoke the checkout component 310 to debit the customer's account.

Security component 316 may embody security on local accounts, or alternatively may communicate with external third party systems to validate accounts. For example, security component 316 may interface with a bank site to confirm that a customer had an account with that bank.

Fulfillment component 308 may communicate with profile component 318 to obtain customer account information. The profile component 318 may be exposed to a customer by way of an application or by way of a web interface. For example, a customer may enter one or more shipping addresses to be associated with. Additionally, fulfillment component 308 may communicate with shipping component 320 configured to queue orders for shipping. For example, fulfillment component 308 may receive a message with a gift ship indicator, which indicates that a purchase is to be fulfilled by shipping to a particular address, rather than being carried out of the store. The fulfillment component 308 may access the proper shipping address from the profile component 318, and then queue an order with the shipping component 320. The shipping component 320 would in turn place the order with the relevant system, for example the stores on-line e-commerce site. Additionally, the shipping component 320 could provide a shipping reference code and via the fulfillment component 308 and the wireless communications component 306 transmit the shipping reference code to the customer's wireless device 302 or 304. Example shipping reference codes may include tracking codes from United Parcel Service, Federal Express, and other third party shipping companies. Accordingly, Profile component 320 in general may support a customer's account and preferences, and serve customer specific information to support mobile electronic shopping.

Fulfillment component 308 may communicate with receipt component 322. Receipt component provides receipts and other confirmations to a customer that a purchase has been completed. Receipts may include an enumeration of products and the respective number of items purchases. Receipts may include a total amount debited. Receipts may include coupons, advertising, and other information that the store, or third party may wish to communicate to the customer. Such other information may be selected based on customer profile information as stored in profile component 318. For example, based on items purchased, and on profile information stored in profile component 318, a receipt may display coupons of frequently purchased items, or advertisements of new alternative products.

Fulfillment component may communicate with reporting component 324. Reporting component 324 provides reports to the store management and other stakeholders about sales in the store. For example, fulfillment component 308 may store a transaction record for every purchase, return, or other transaction performed, in transaction storage 326. In the case of processing order messages, the fulfillment component 308 may provide persistent state of customers' virtual shopping carts in transaction storage 326. Transaction storage 326 may be a database hosted on a database server, such as a relational database. Reporting component 324 may interface to the transaction storage 326 and to the inventory system interface 312. Upon receiving report requests, the reporting component 324 may generate and serve the corresponding report. Reports may be generated in real time, for interactive sessions such as in an on-line analytical processing system (“OLAP”); in batch, for offline sessions such as overnight reporting, and on demand such as in an interactive reporting system.

Example reports may include:
1. Shopping order report: Statistics of products purchased in store over a period of time;
2. Cart size report: Statistics of how many items customers purchased during a single store trip, where a trip may be a single physical trip to the store, a single communications session with the fulfillment component, or a purchase indicator;
3. Purchase size report: Statistics of the monetary amount customers purchased during a single store trip;
4. Duration of in-store stay report: Statistics of the amount of time customers stayed in store during a store trip;
5. Favored items report: Statistics of products most purchased over a period of time;
6. Abandoned items report: Statistics of products scanned, but then removed from purchase by customers over a period of time;
7. Act on coupon report: Statistics of products whose purchase was associated with a coupon;
8. Act on discount report: Statistics of products who purchase was associated with a discount or other sale promotion; and
9. Average transaction size report: Average statistics of the identity and number of products purchased by customers and the monetary amount.

Reporting component 324 has access not only to statistical functions, but may also be programmed with one or more analytics models. An analytical model specifies a set of data to retrieve, for example from the transactional storage 326, one or more statistical operations to perform on the data, criteria on how to identify a statistically significant trend, such as specifying predetermined thresholds for the statistical operations, and a directive on how to interpret such trend. In one example, a statistical model may analyze the effects of a coupon sale on soap brand X in the month of June by specifying:
1. Data to Retrieve: All transactions of actual purchases of soap brand X and soap brand Y in June of the present year and all actual transactions of purchases of soap brand X and soap brand Y in June of the previous year. Then all transactions of abandoned orders of soap brand X and soap brand Y in June of the present year and all abandoned orders of orders of soap brand X and soap brand Y in June of the previous year.
2. Statistical Operations: Calculate the total count of the actual purchases of soap brand X versus soap brand Y per day and the ratio of abandonments of soap brand X versus soap brand Y per day for both June of the present year and June of the previous year.
3. Criteria to Detect Statistically Significant Trend: Determine whether the sales of soap brand X exceed sales of soap brand Y on a daily basis. Determine whether the amount that sales of soap brand X exceed soap brand Y on a daily basis is more by a predetermined threshold in June of the present year than June in the previous year. Determine whether the ratio of abandonments of soap brand Y with respect to soap brand X is more by a predetermined threshold in June of the present year than June in the previous year. Determine that the ratio of abandonments linearly correlates to any detected increase in soap brand X actual purchases in June of the present year when compared to the previous year.
4. Directive to Interpret Trend: If all of the previous determinations are affirmative, then produce a report stating that the coupon sale was effective in drawing customers from soap brand Y to soap brand X.

The previous example is but one of many possible analytical models. The previous example illustrated a retrospective analysis on a past soap coupon campaign. However, analytical models may also be predictive. Specifically, an analytic model may seek increasing trends, or may detect spikes correlated to particular days or events. Upon detecting these criteria, an analytic model may predict future product trends. For example, an analytic model may predict increased ice cream sales on the second Monday of every April, whereupon a store owner may discover to be an administrative holiday at the local elementary school.

Reports may be made available via a user interface 328. The user interface 328 may receive report requests, and may display reports served by the reporting component 324 and received via fulfillment component 308. Specifically, the fulfillment component 308 may communicate with user interface 328 either locally or remotely. For local scenarios, the user interface may be part of a monolithic embodiment of a fulfillment system 300. For remote scenarios, the user interface 328 may be on a remote personal computer or other terminal and may be integrated into an application. One example application may include a dashboard application which shows summary reports on a dedicated portion of a user interface. Another example application would be an interactive reporting application on a client computer, where a user made requests for particular reports, and was presented with the corresponding report served by the reporting component 324. Reports need not be received in an interactive application. For example, report requests may be served via e-mail or text messaging.

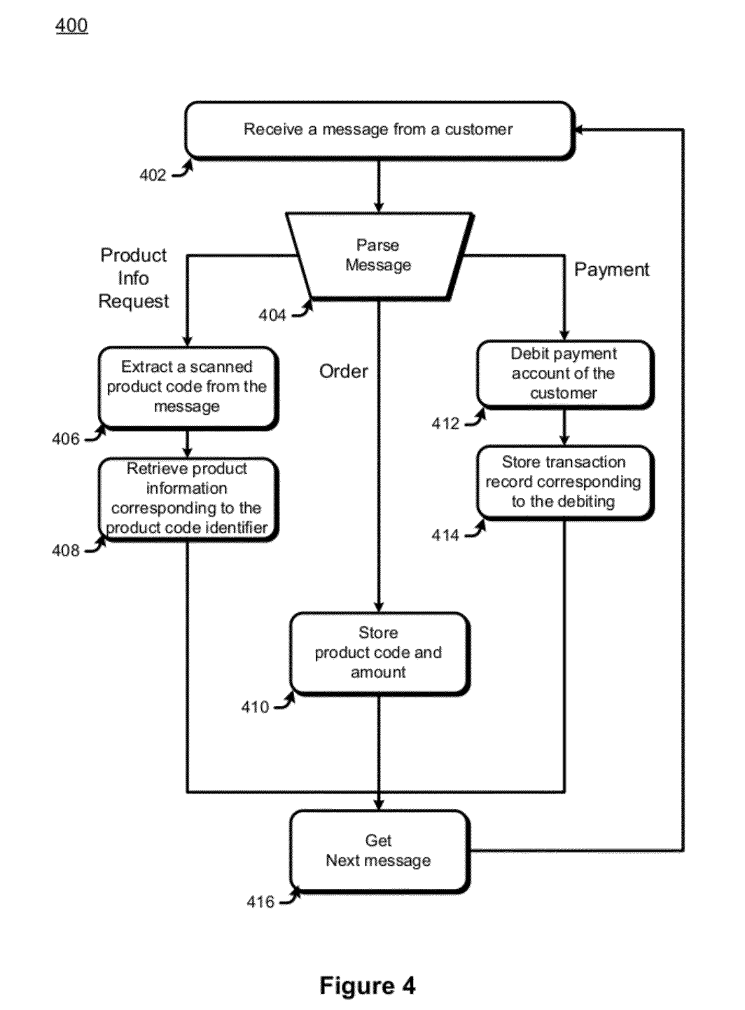

As described with respect to FIG. 3, the fulfillment component 308 receives messages via the wireless communications component 306. FIG. 4 illustrates an example of message processing 400 by fulfillment system and environment 300.

In block 402, the fulfillment component 308 receives a message. Messages may be queued to enable serialized processing.

A message is generally a contiguous set of bits containing information in a format that may be parsed by the fulfillment component 308. The contiguous bits may be subdivided into subsets of contiguous bits called fields. Each field may be interpreted as a command, a parameter, a flag, or a data field. Messages generally include a command, and associated information. Example messages may include:
1. Product Information Request: Command is to receive information about a product either from the inventory system, or from a third party. The message includes a scanned product identification code such as a product identification number, and a flag indicating whether the information request is from the inventory system or a third party. Where a third party system is requested, the address, such as the URL, of the third party system is included in the message. Any parameters for the inventory system or for the third party system are also included in the message.
2. Order Request: Command is to add a scanned product identification code such as a product identification number to a list of items to be purchased. The list of items may be stored in a database associated with the fulfillment component 308 such as the transaction storage 326. The message includes the product identification code and a number of items to be purchased. There may be a field indicating the units for the number of items. For example, for produce, pounds may be specified rather than an item count. Optionally, price information such as posted price, coupons and discount may also be included in the message.
3. Payment Request: Command is to purchase all products that have been ordered by previous order requests that have not yet been purchased. The command may be in the form of a purchase indicator such as a flag or command code. The message may include coupon codes and/or discount codes to apply to the purchase. The message may also include a field indicating the means of payment, such as by credit card, or by specifying some other customer financial account suitable for payment.
4. Gift/Ship Request: Command is similar to the Payment request, except that it includes additional fields specifying an indicator of an address of where to ship the purchased items. The indicator may correspond to an address in the customer's profile in the profile component 318.

In block 404, the received message is parsed and divided into its separate commands, parameters, flags, and/or data fields. Subsequent execution is determined by the command.

For example, if the command is a product information request, execution proceeds to block 406 where the scanned product identification code, such as a product identification number is extracted.

In block 408, the flag indicating which database to use, inventory or third party, is extracted. If the database to use is a third party database, then the address of the third party database is also extracted. Any additional parameters in the message to query the database are also extracted. From the extracted database information, a query is formed and the database queried. The product information corresponding to the product information code is thereby retrieved.

By way of another example, if the command is an order request, in block 10, the product identification code, such as a product identification number is extracted from the message along with an item count and other parameters. This information is converted into a transaction record and stored in the transaction database 326.

By way of yet another example, if the command is a payment request, in block 412, the transaction database 326 is queried for all transaction records of products ordered corresponding to the customer. For example, the query may retrieve all transaction records marked as unpurchased and unreturned with a customer account number, along with any coupon and/or discount fields. A subtotal amount of the transaction records would be calculated, and any global coupons and/or discounts as indicated by the payment message fields would be applied to create a final total. Then based on the payment method field of the payment message, the customer's account would be debited by the final total.

In block 414, the transaction record corresponding to the debiting would be recorded in transaction database 326. This may be accomplished by marking all transaction records for the purchase as completed, and associated with a unique transaction identifier and date/time stamp. In this way, reports about past transactions may be generated by queries on the transaction records.

The fulfillment component 308 is not limited to the above exemplary messages. The fulfillment component 308 may be programmed process an arbitrary message, where a component of the fulfillment system 300 is invoked, and/or queries against the transactional database 326 or external data sources are to be performed.

After a message is processed, in block 416, the fulfillment component may return to get the next message to be processed.

### Exemplary Analytics for Customers

One of the advantages of the fulfillment system 300 in tracking transactions in transaction storage 326 is the ability to perform analytics on behalf of the customer. Just as, reporting component 324 may generate analytics about store performance and product sales from the perspective of the store and the store's stakeholders, reporting component 324 may generate analytics about purchase trends from the perspective of the customer. As previously described, reporting component 324 may be programmed with analytical models comprising a set of data to analyze, a set of statistics to compute on the set of data, a set of criteria to determine a statistically significant trend, such as setting predetermined criteria, and a directive on how to interpret the trend.

Analytical models may be applied to customer trends both retrospectively and predictively. One example of a retrospective report is to indicate that the customer has saved a certain percentage of money by participating in a grocery club card program. One example of a predictive report is to indicate that a customer buys a 10 pound bag of rice every two months, and for the upcoming month is likely to need another bag of rice. In this way, the analytical model can provide a suggested shopping list service to the customer comprising a list of products and amounts purchased based on the time interval from the last purchase.

Predictive analytic models may be further refined by the customer storing known purchase patterns in their customer profile in profile component 318. Accordingly, if reporting component 324 has access to profile information in profile component 318, any analytic model may be refined accordingly.

One example of profile information being used to enhance an analytic model is to determine whether a customer is associated with a predefined group of people. A predefined group is a group of customers whose purchase patterns are related either by association or by similarity. For example, a group of customers may represent a family, which is a group by association. By way of another example, a group of customers may be members of the same social networking group, which is a group by similarity.

Accordingly an analytic model may incorporate group information by specifying data to retrieve filtered by group and by detecting trends by comparing statistics computed by group.

Just as an analytic model may detect similarities and correlations between predefined groups, an analytic model may detect similarities and correlations between an individual customer and a group. In some cases, it may be advantageous to automatically add that individual customer to a predefined group, by modifying the customer's profile by automatically joining the customer to a social networking group when the customer satisfies some predetermined criteria. For example, if a user typically buys clothing with a logo for a particular sports team, that user might be joined to a social networking group of fans of that sports team.

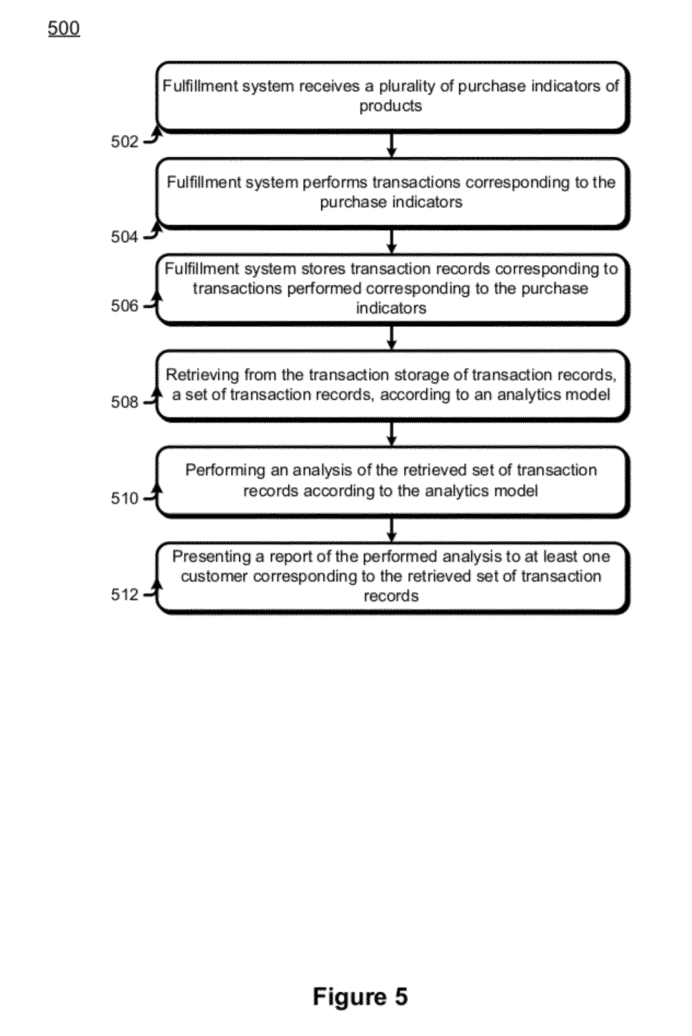

FIG. 5 is a flow chart 500 of a reporting process. In block 502 the fulfillment system 300 receives a plurality of purchase indicators, for example via purchase messages. In block 504, the fulfillment system 300 performs the purchases commands as described above with respect to FIG. 4. In block 506, the purchases stores transaction records corresponding to the performed purchase indicators. As described above, the storing may include changing a field in a transaction record entered by an order command, to show that the order was purchased, rather than abandoned. At this point, there should be a set of transaction records, for example stored in the transaction storage 326, to analyze.

In block 508, the reporting component 324 retrieves a set of records according to an analytics model. Specifically, the analytics model specifies a subset of data to query, upon which analysis will be performed.

In block 510, the reporting component 324 performs an analysis of the data retrieved in block 508 according to the analytics model. The analytics model will specify what statistics to calculate on the retrieved data, will specify predetermined thresholds to detect statistically significant trends, and will provide directives on how to interpret those trends.

In block 512, reporting component 324 will generate a presentation that may comprise the interpretation, the underlying statistics, and/or how those statistics satisfied or failed to satisfy predetermined thresholds. The presentation may asynchronous, for example in the form of an email message to the customer. Alternatively, the presentation may be synchronous, for example by the customer using a web interface to access his or her profile.

### Extensibility Model via Application Programming Interface

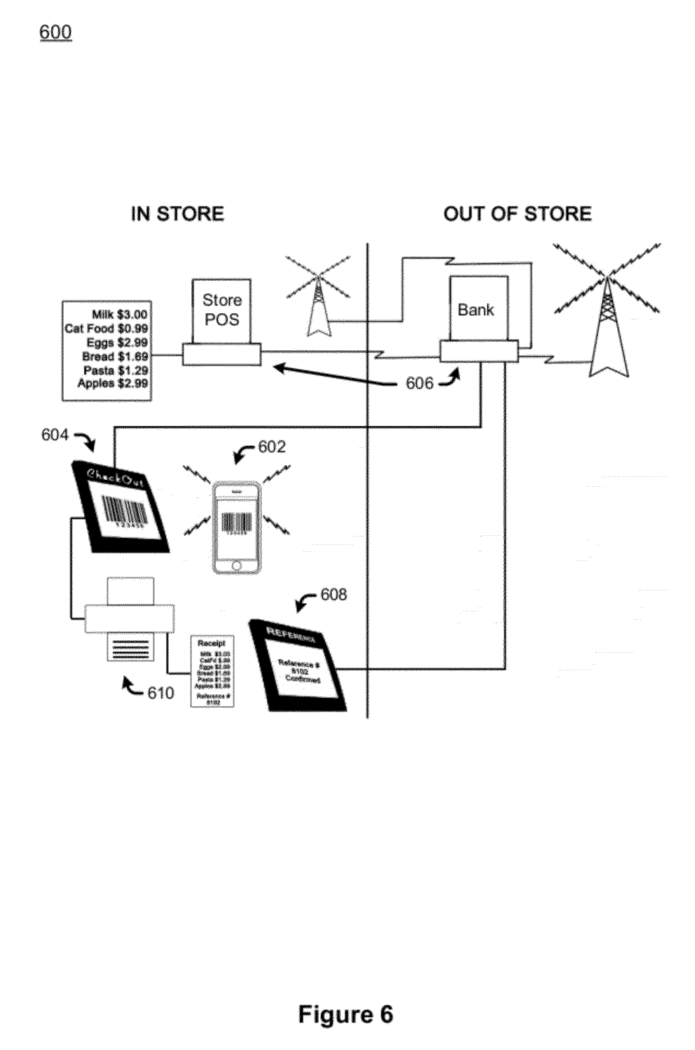

FIG. 6 illustrates one example 600 of how a fulfillment system 300 may integrate with a point of sale system and with the customer's funds. After a user has scanned products to be purchased with a wireless device 602, the customer may go to a kiosk 604 and wirelessly transmit the purchased products list along with a customer identifier via wireless communications component 306. The kiosk 604 will then perform a transaction 606 against the customer's accounts via checkout component 310. If the transaction is successful, the kiosk 604 can display 608 or transmit to the wireless device 602 a confirmation code. The kiosk 604 may also print out a paper receipt 610 or alternatively transmit an electronic receipt to the customer via receipt component 322.

Interfacing the fulfillment system 300 with a point of sale system or inventory system may be effected via an application programming interface (API). Specifically, existing point of sale or inventory systems support a standard file format with which to enumerate electronic transactions. The fulfillment system 300 may expose an API call which receives the purchase list in a predetermined file format. In this way, the point of sale or inventory system may use the purchase list to modify inventory counts. The point of sale or inventory system may also track user purchasing habits as well for future data mining.

Customer accounts may include bank accounts, credit card accounts, gift card accounts, and third party cash accounts. One example of a third party cash account is the conversion of a coin pour into a coin counting machine. A customer enters a large amount of accumulated spare change (called a “pour”) into a coin counting machine. The coin counting machine then totals the monetary value of the entire pour. The coin counting machine may then create a temporary online debit account, which the customer may use to make purchases in participating stores. Alternatively, the coin counting machine may perform a credit against a customer's bank account or gift card. In another embodiment, the coin counting machine may transmit a coupon directly to the wireless device which may then be used to make purchases.

### Exemplary Wireless Device Embodiment

The foregoing discussion described the fulfillment system 300. This section will describe the wireless device and its resident application software.

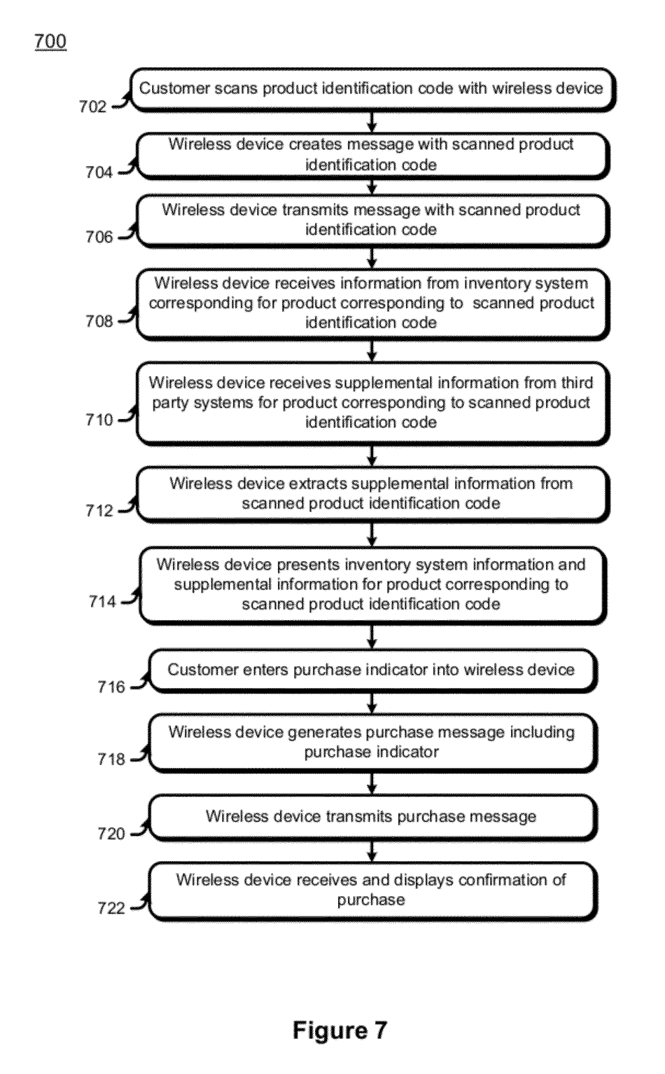

FIG. 7 provides a flowchart 700 of a generalized operation of the wireless device. In block 702, a customer will scan a product identification code with a wireless device. In block 704, the wireless device will create a product information request message from the scanned product identification code. Upon message creation, in block 706, the wireless device will transmit the product information request message to the fulfillment system 300.

In response to the transmitted product information request message, the wireless device will receive product information corresponding to the scanned product information code in the product information request message, from the fulfillment system 300. Typically, the product information will be from the inventory system 314, via the inventory system interface 312, and may comprise pricing information.

The customer may also desire information about the product not related to the mechanics of purchase, i.e. product price, product unit, sales, and discounts. Rather the customer may desire information to supplement the product purchase information. Specifically, the customer may desire information on how to perform an informed choice, including information how the product was used, third party reviews, comparative pricing information, and information about the company producing the product.

Note that fulfillment system 300 supports queries to third party information sources. In block 710, the wireless device may obtain supplemental information by querying third party sources.

Similarly, product information codes, such as QR codes may contain supplemental information. In block 712, the wireless device may parse the scanned product information code for supplemental information. In cases where the supplemental information is a directive, the wireless device may perform the directive. For example, a QR code may contain a web address of an internet site containing the supplemental information. In this case, the wireless device will access the web site, and retrieve the supplemental information.

Once the product purchase information and/or the supplemental information are collected, the information is combined and present to the customer in block 714. Upon reviewing the presented, combined information, the customer may enter a number of items to order, and then may order the product via an order message.

Once all desired products are ordered, the customer may seek to purchase the ordered items. In block 716, the customer commences the purchase process. This may be in the form of clicking on a button, or via spoken voice command. The effect is to generate a purchase indicator that is a command to start the purchase process. The purchase indicator may be a simple command field. Alternatively, the purchase indicator may be encrypted and may include wireless device information and customer identifier information, such as account number, to preclude spoofing.

In block 718, the wireless device creates a purchase message from the purchase indicator. The purchase message may include other account information, such as validation information in the form of a password. Additionally, the purchase message may include coupon and discount information to be applied to purchase. When the purchase message is generated, the wireless device transmits the purchase message to the fulfillment system 300 in block 720.

In block 722, the wireless device receives a confirmation from the fulfillment server 300, in response to the purchase message. For example, the confirmation may be in the form of a confirmation code. The confirmation code may be based on a unique transaction identifier in transaction store 326 that identifies all transaction records relating to the purchase.

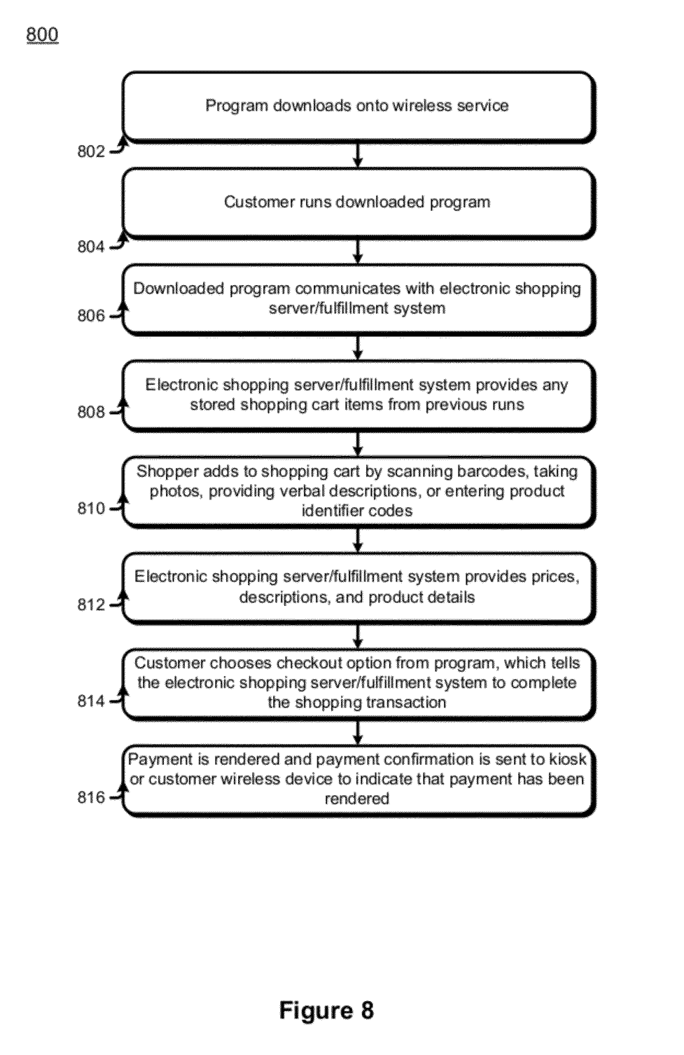

FIG. 8 provides an exemplary workflow 800 for mobile electronic shopping. In block 802, the wireless device is configured with mobile electronic shopping software. Specifically, a customer downloads a mobile electronic shopping software program to the customer's wireless device. In block 804, the customer may then run the mobile electronic shopping program.

In block 806, the mobile electronic shopping program will handshake with the fulfillment system 300, for example through the wireless communications component 306. Upon operation, the mobile electronic shopping program identifies the fulfillment system 300 as an electronic shopping server. The electronic shopping server may store the state of the mobile electronic shopping program, such as stored shopping cart items from previous runs, failed transactions, or security audit information, for example via transaction storage 326. In block 808, the mobile electronic shopping program may initialize by retrieving its stored state, as to indicate to a customer about previously ordered, but unpurchased items.

Once the mobile electronic shopping program has its state reinitialized, the customer may perform shopping operations in block 810. Shopping operations may include inputting additional products for purchase, removing products for purchase, price checks and obtaining product information. Input methods include, but are not limited to the input methods described in reference to FIG. 2. As products are input into the wireless device, the electronic shopping server/fulfillment system 300 in block 812 will provide product information which may include prices, descriptions, product details, ratings, and user commentary.

After shopping operations, in block 814 a customer may perform checkout. Checkout may include interfacing via a pre-existing kiosk, or via direct communication with an electronic shopping server/fulfillment system 300. Once the customer provides notification to checkout, for example in the form of a purchase indicator in a message, payment may be rendered. Payment may include access to accounts including, but not limited to bank accounts, credit card accounts, gift card accounts and third party accounts. Upon payment, in block 816, the customer may receive confirmation from the electronic server or other portions of a point of sale system of a successful transaction, and/or a receipt.

### Exemplary Operational Contexts

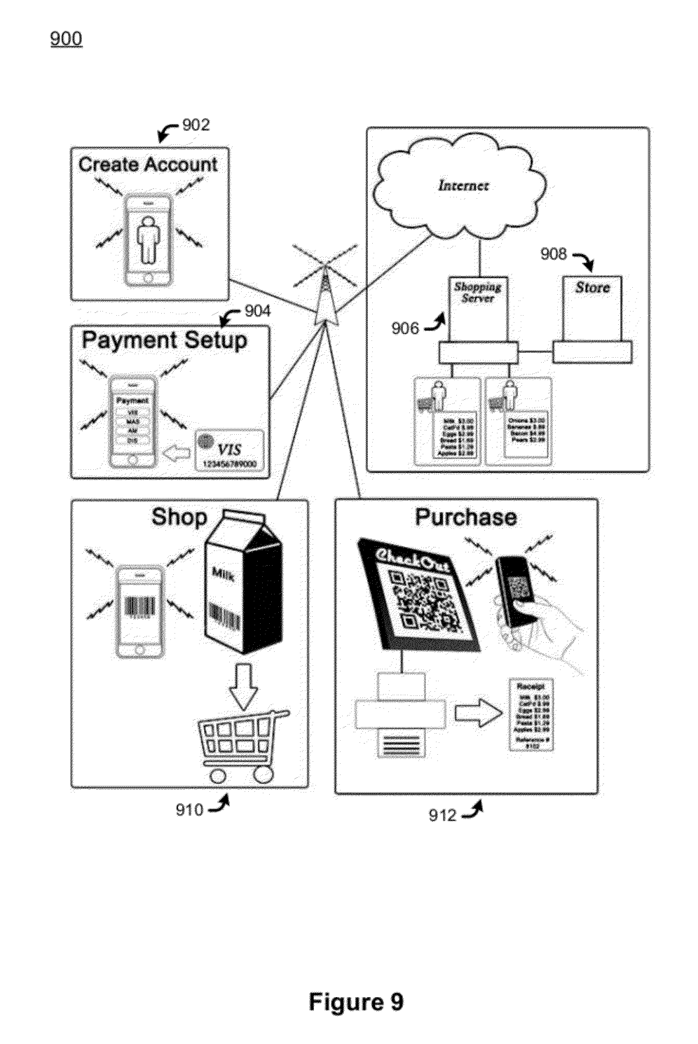

FIGS. 9 through 14 illustrate various non-limiting contexts where mobile electronic shopping may be situated. Mobile electronic shopping includes, but is not limited to provisioning a mobile electronic shopping account, performing shopping operations, effecting payment and fulfillment.

FIG. 9 illustrates mobile electronic shopping operations 900 within a brick and mortar store. Payment is made possible in mobile electronic shopping by virtue of associating a wireless device with a customer's funds. This may be performed via provisioning a mobile electronic shopping account 902. The mobile electronic shopping account 902 may include identification information such as name, address, other contact information, and security/logon/password information. Various payment accounts 904 may be associated with the account including, but not limited to bank accounts, credit card accounts, gift card accounts and third party money accounts. An account 904 may be associated with multiple payment accounts. In some circumstances, such as for spouses and joint payment accounts, an account may be associated with multiple users.

The account may be stored on an electronic shopping server 906 that is associated with one or more stores 908. The account 904 will be associated with the transaction histories of the user. For example all receipts of purchases by the user may be stored on the electronic shopping server 906. If a shopping cart 910 has been filled, but not paid, the electronic shopping server may store the shopping cart 910 as account state.

Accordingly, the wireless device may invoke the provisioned mobile electronic shopping account 904 when performing shopping operations, purchases, and other mobile electronic shopping operations as described below.

In the alternative, a user who wishes not to set up an electronic shopping account 904 may still enter credit/debit card information into the wireless device to effect payment. Credit/debit card information may be entered, via a camera 912 reading the credit card number on the card, manual entry, or voice entry.

In the case where a camera reads the credit card number on the card, the wireless device will first take a digital image of the credit card. In the digital image, software on the wireless device will locate and orient the credit card number and expiry within the digital image. For each number software on the wireless device will identify the portion in the image corresponding to the number and perform a number identification. The software will match the images against expected patterns, for instance the expectation of 16 digits in many U.S. credit cards, or a 4 digit plus 3 digit CCV number on the back of many U.S. credit cards. The software may ask the user to verify the credit card number prior to use. Upon verification, the credit card number and other relevant information will be submitted for payment. For security, the digital image and the extracted credit card information are not permanently stored.

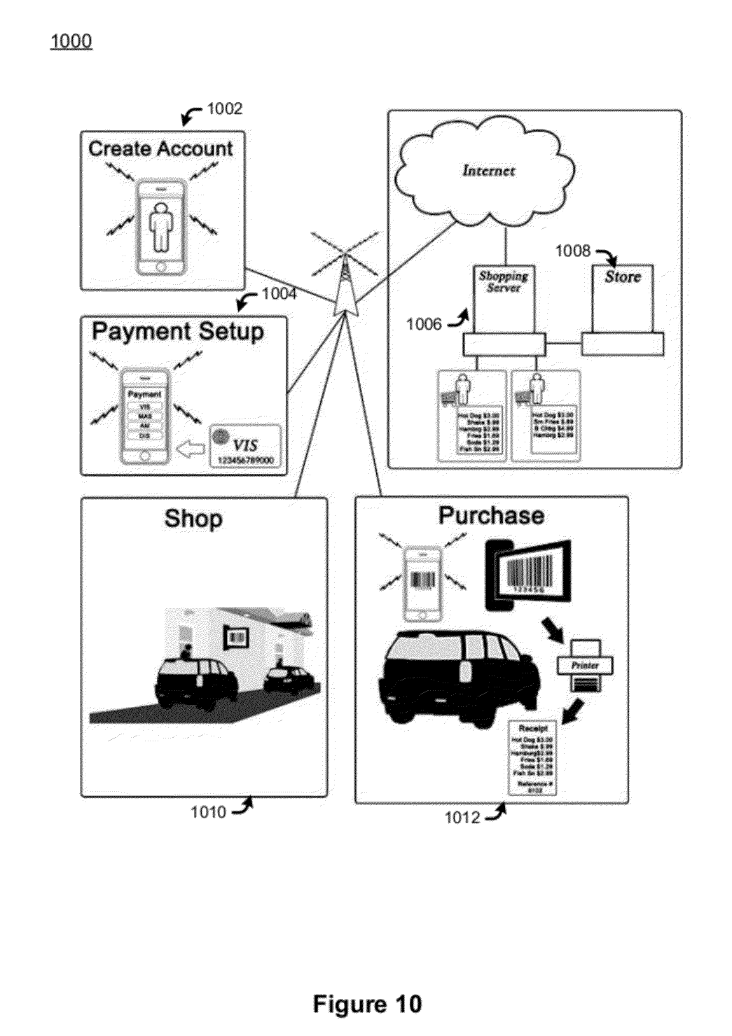

Turning to FIGS. 10 through 14, the provisioning, payment and fulfillment operations are similar as described with reference to FIG. 9 except as specified below.

FIG. 10 is an illustration of mobile electronic shopping, i.e. shopping remote from a fulfillment and payment location 1000. As in FIG. 9, FIG. 10 has an analogous wireless device account creation process 1002, provisioning 1004, with a fulfillment system 300 on a server 1006 associated with one or more stores 1008. Specifically, a wireless device may be used to provide payment at a drive through. At the drive through 1010, a screen with a bar code may be used to make orders 1012. Alternatively, the customer may order remote from the drive through and simply use the drive through for order pickup and to effect payment. The customer makes a checkout notification on the wireless device to effect payment. A printer may provide a paper receipt, or alternatively the electronic shopping server may send an electronic receipt.

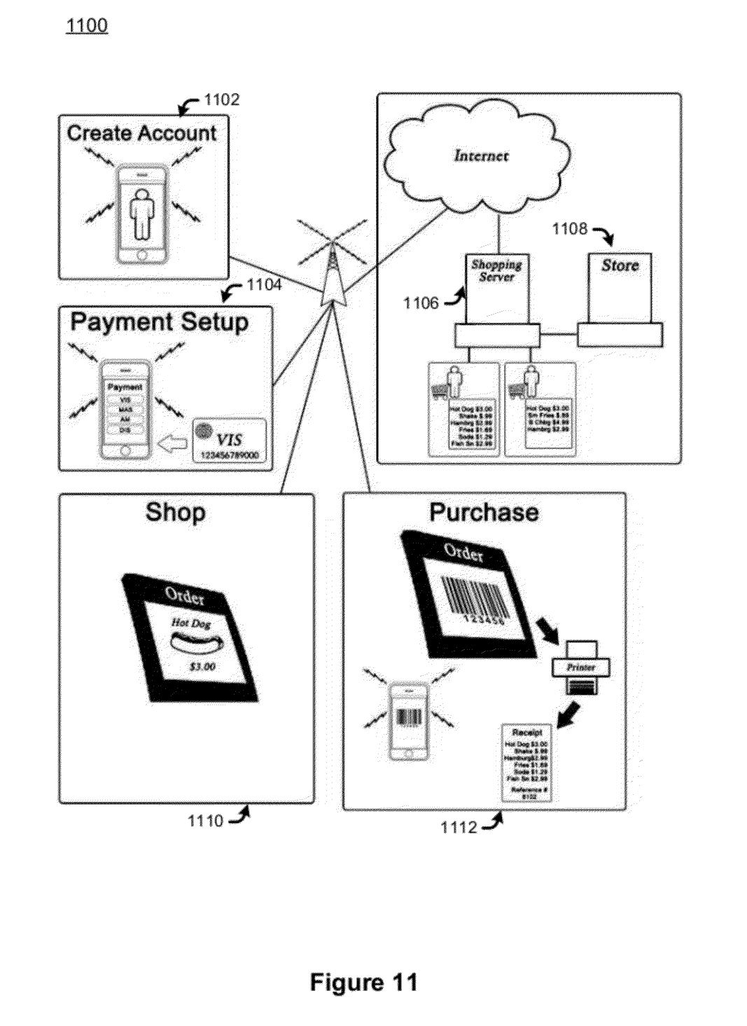

FIG. 11 illustrates a retail store option that provides a display of items for sale on a kiosk 1100. As in FIG. 9, FIG. 11 has an analogous wireless device account creation process 1102, provisioning 1104, with a fulfillment system 300 on a server 1106 associated with one or more stores 1108. The kiosk may display bar codes corresponding to items for purchase which are scanned or otherwise entered into the wireless device 1110. The customer may then may a checkout notification and effect payment 1112.

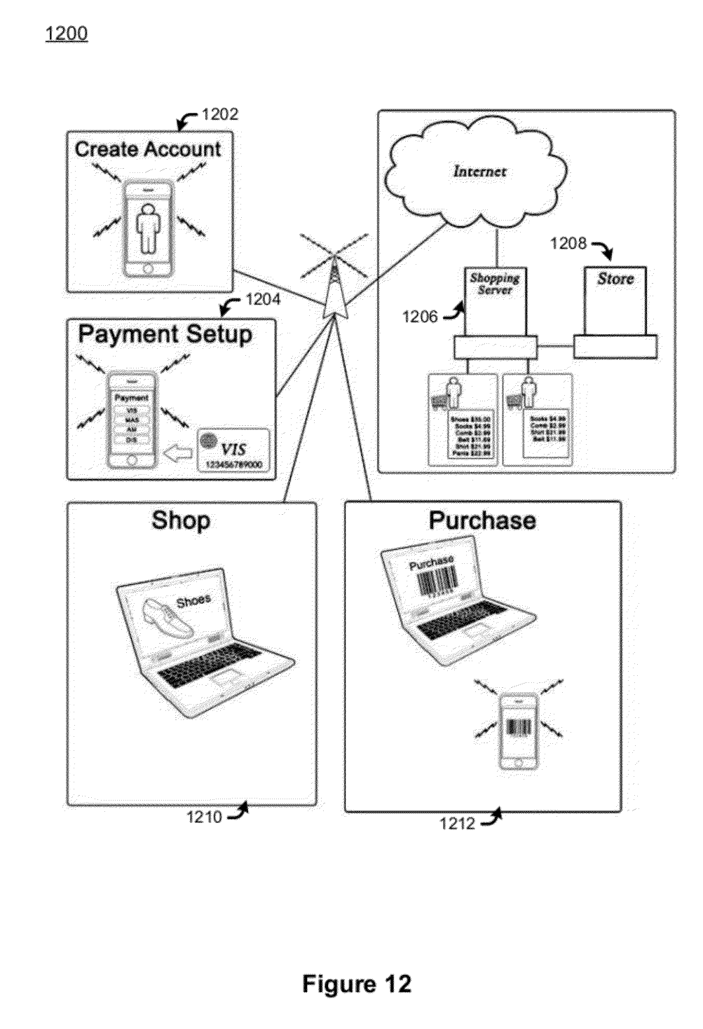

FIG. 12 illustrates an online shopping option where an item is displayed on a laptop computer or monitor for a computer 1200. As in FIG. 9, FIG. 12 has an analogous wireless device account creation process 1202, provisioning 1204, with a fulfillment system on a server 1006 associated with one or more stores 1208. The computer may display bar codes corresponding to items for purchase which are scanned or otherwise entered into the wireless device 1210. The customer may then may a checkout notification and effect payment 1212.

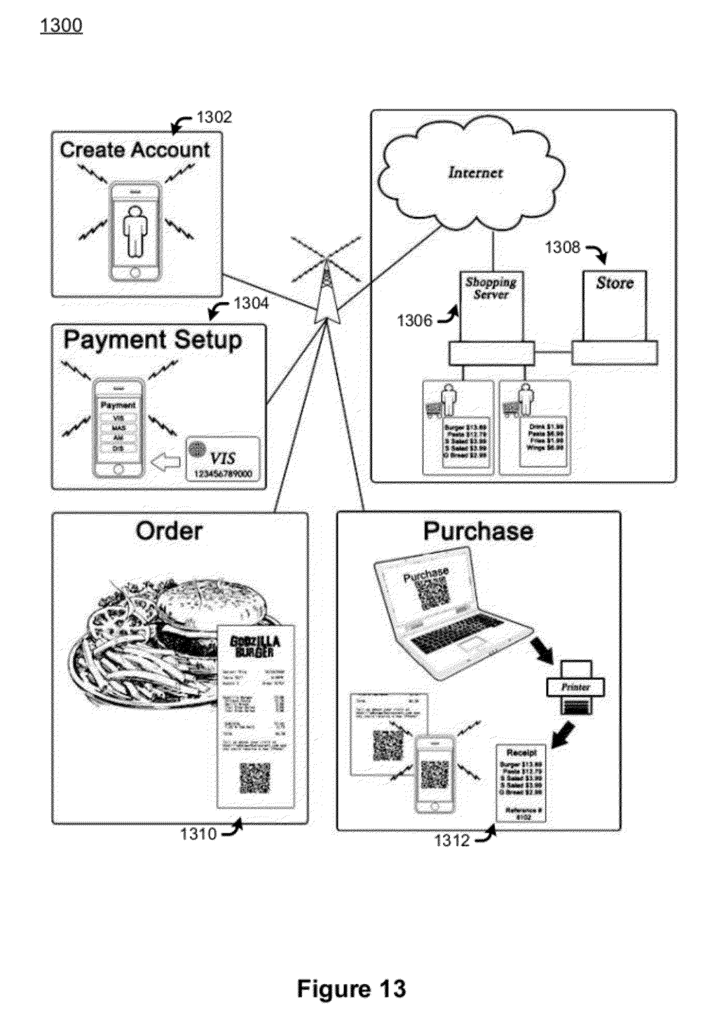

FIG. 13 illustrates environments where a computer screen is not available 1300. As in FIG. 9, FIG. 13 has an analogous wireless device account creation process 1302, provisioning 1304, with a fulfillment system 300 on a server 1306 associated with one or more stores 1308. For example, a restaurant may have an order accompanied with a bill with a bar code enumerating items purchased 1310. The wireless device may scan the bar code enumeration, and the user may then may a checkout notification and effect payment 1312.

There are many contexts in which a computer screen is not available. In general, a fulfillment system 300 may enable a signage based billing system. Specifically, a vendor may post signs containing product identifications codes that may be scanned. The customer may subsequently scan the product identification code and then initiate a purchase. In one specific scenario, instead of parking meters, a municipality may simply post scannable signs at specified parking spaces. A customer may park a car in the space, scan a bar code on the scannable sign, and then take a picture of the car's license plate. The customer's wireless device may then send a message with a purchase request for parking comprising the identity of the slot, payment mode, time, license plate, and a date/time stamp. The municipality in turn may have custom reports that indicate cars that have exceeded their time in the parking space, and may remotely issue parking tickets. Alternatively, the municipality may post a web site to the public indicating the location of unoccupied parking spaces.

In another scenario, billboards and posters may provide scannable codes whereupon a customer may make an impulse purchase by scanning the code. Upon scanning the code, the customer may use the wireless device to send a gift/ship message to deliver the purchased item to his or her residence.

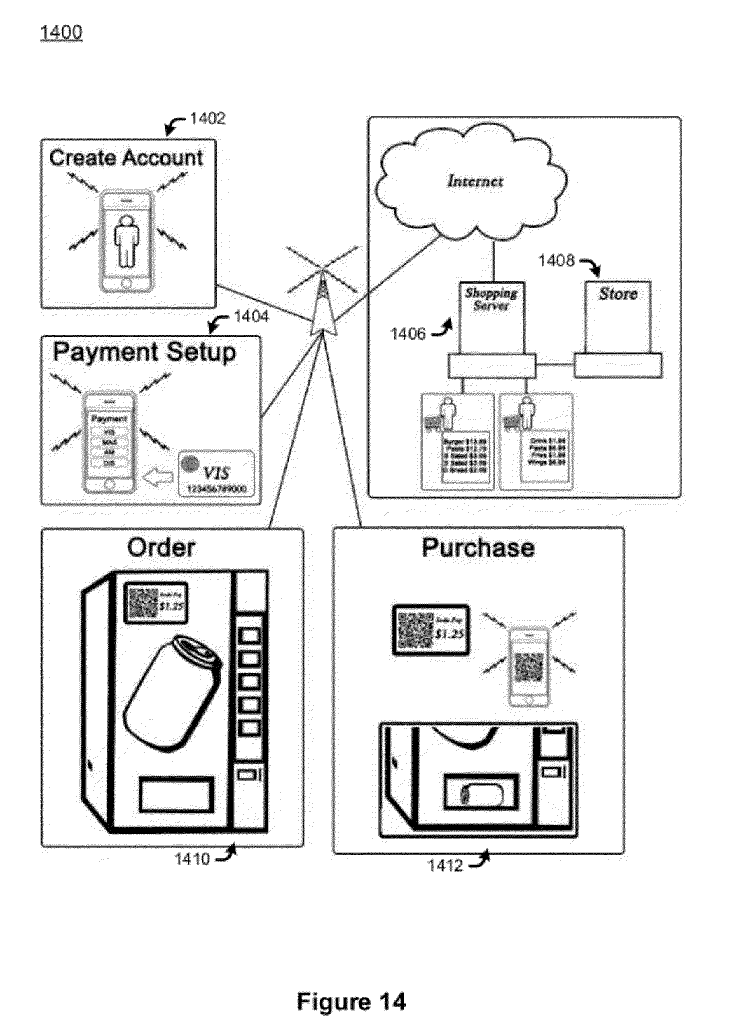

FIG. 14 illustrates environments where a computer screen is not a full size screen 1400. As in FIG. 9, FIG. 14 has an analogous wireless device account creation process 1402, provisioning 1404, with a fulfillment system 300 on a server 1406 associated with one or more stores 1408. For example, a vending machine may display a bar code on a small screen 1410. The wireless device may scan the bar code on the vending machine, and the customer may then may a checkout notification and effect payment. Upon receipt of payment, the vending machine dispenses the purchased product 1412.

### Exemplary Integration with Peripherals

Thus far, the wireless device has scanned product costs from bar codes in static situations. Specifically, the cost of an item to be purchased stays the same. However, there are situations where the cost of an item may vary. One such scenario is for products whose cost varies by weight. To support these scenarios, the wireless device may integrate with peripheral devices that display a bar code after ascertaining price.

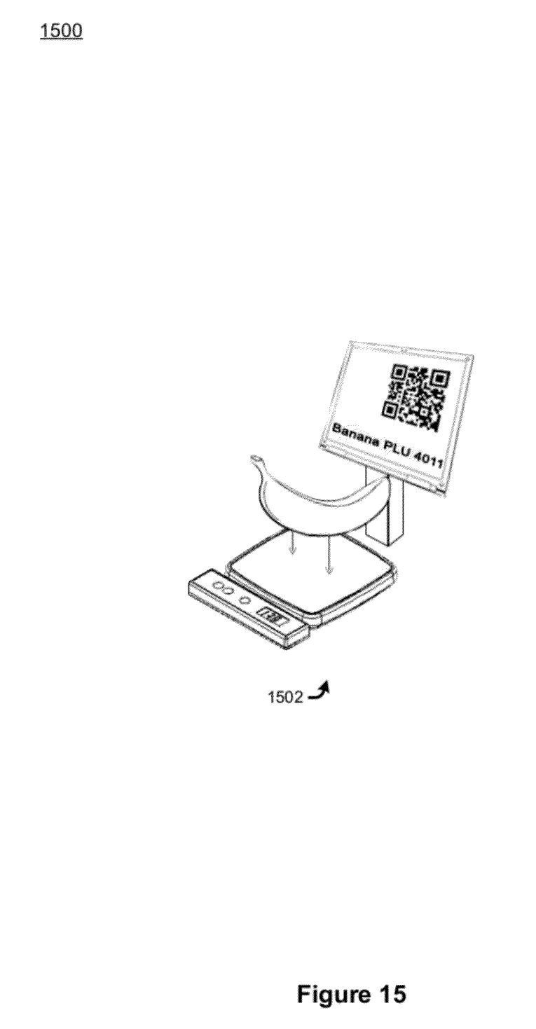

FIG. 15 provides an illustrative embodiment via a digital scale 1502. A customer may enter into the digital scale an identifier of a product to be weighed, for example a banana. The electronic shopping server/fulfillment system 300 will then provide the cost per unit weight of the banana. The customer then weighs the banana. Based on the weight and the cost per unit weight, the digital scale displays a bar code that identifies the product and the cost. The bar code may then be entered into the wireless device and placed into the mobile electronic shopping account's shopping cart.

Such integration is not limited to digital scales 1502. For example, a customer who wishes to perform a currency conversion where a first currency is entered into a machine and counted may then have the wireless device accounts credited in a second currency, according to the present currency conversation rate, by displaying a bar code. In general, any peripheral device that can make a determination of a cost and that can display a bar code may accordingly interface with the wireless device.

### Exemplary Integration with Standards

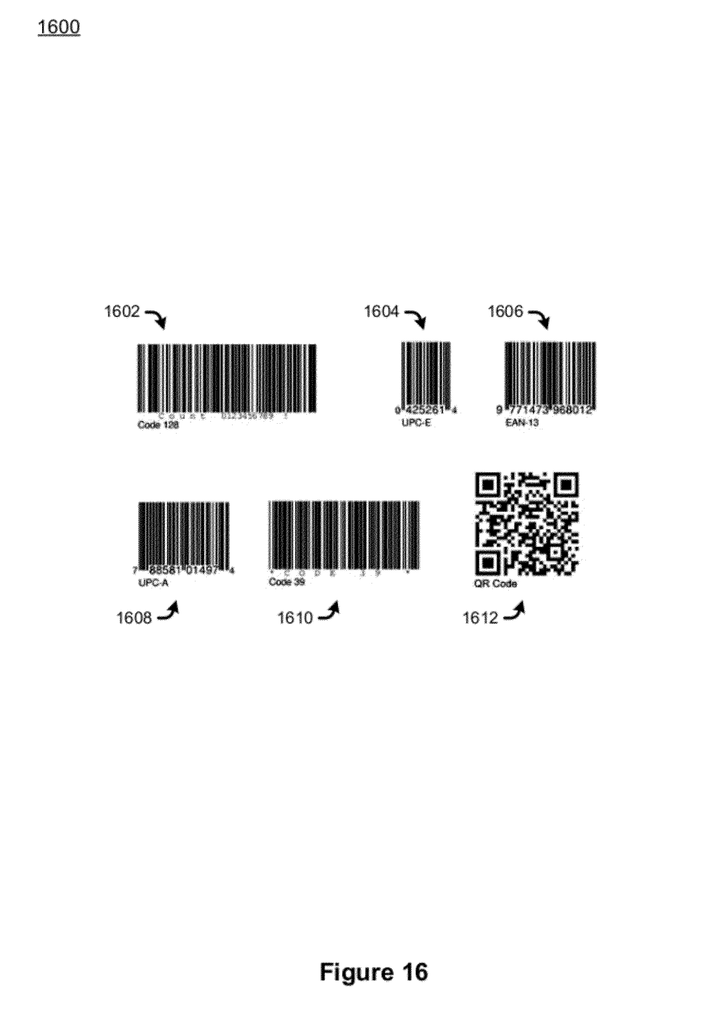

The wireless device may receive data in any number of formats, including standardized bar code formats. FIG. 16 illustrates some standardized bar code formats supported by mobile electronic shopping, including, but not limited to Code 128 1602, UPC-E 1604, EAN-13 1606, UPC-A 1608, Code 39 1610, and two-dimensional QR-Code bar codes 1612.

### Exemplary Mobile Electronic Shopping Client and Server Operation

As described above, mobile electronic shopping enables purchasing regardless of a customer's location. The customer may be remote from the location of purchase and fulfillment. Alternatively the customer may be in an arbitrary brick and mortar store. In effect, the wireless device operates as a universal purchasing device supporting multiple forms of payment, search, fulfillment and reporting.

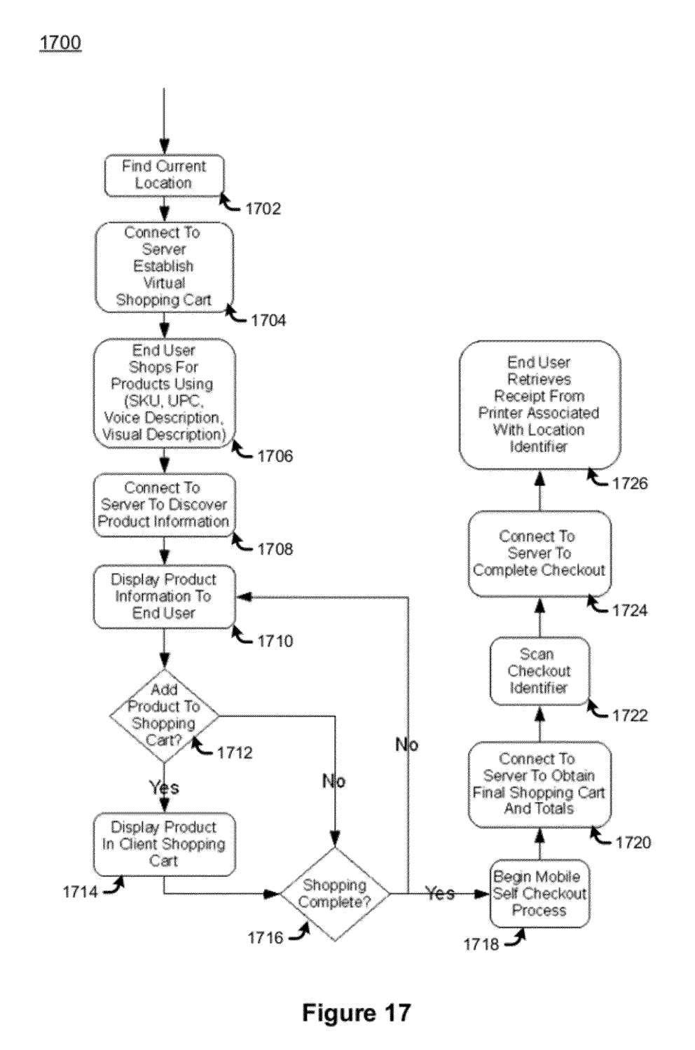

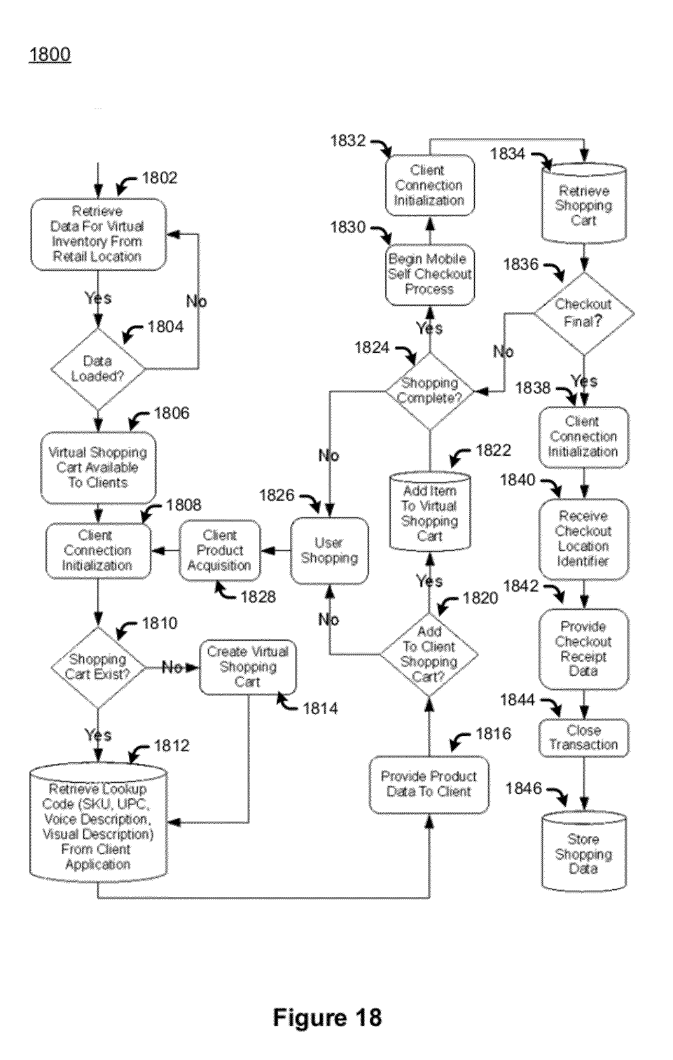

Just a customer may be remote from a store, a customer may be in a local store but the fulfillment system 300 may be remote from the local store. In particular, the fulfillment system 300 may be resident on an electronic shopping server remote from a local store, and the electronic shopping server may provide fulfillment services via the fulfillment system 300 for multiple local stores. Thus, in one embodiment, the wireless device is able to determine location as part of the handshaking process and interaction process with an electronic shopping server, which in turn provides the fulfillment system 300 services. FIGS. 17 and 18 describe exemplary wireless device client operations 1700 and server side fulfillment system 300 operations 1800, for mobile electronic shopping operations respectively.

Regarding wireless device client operation as in FIG. 17, a wireless device client will identify a mobile electronic shopping server/fulfillment system 300 in block 1702. Specifically a client will determine its location via global positioning satellite (GPS), cell tower triangulation, or any number of other geolocation facilities.

Once location is determined, in block 1704, it may obtain a location identifier, from an internal lookup table, or from accessing a global server, and then may identify a mobile electronic shopping server/fulfillment system 300. Once a mobile electronic shopping server/fulfillment system 300 is identified, the wireless device will establish a connection and will create a virtual shopping cart. The aforementioned is not intended to be an exhaustive list. Additional operations not described include, but are not limited to restoration of session state and account management.

After handshaking with a mobile electronic shopping server/fulfillment system 300, in block 1706, a wireless device client will be used to perform shopping operations. As products are scanned or product identifier codes such as SKU and UPC codes are otherwise input into the client via voice or visual description methods, the wireless device client in block 1708 will query the mobile electronic shopping server/fulfillment system 300 via the inventory system interface to discover product information. Product information may include price and descriptive information, or may include third party content such as ratings, reviews, commentary, and third party social shopping lists. Upon retrieval, in block 1710, the wireless device client displays the product information.

The customer may opt 1712 to add the product to the virtual shopping cart. If the customer does so, in block 1714 the client virtual shopping cart will provide a user interface indication, that the item has been added to the cart. Alternatively, a customer may remove an item from the list; similarly resulting in the client virtual shopping cart providing a user interface indication 1714, that the item has been deleted. In the fulfillment system 300, the deletion may not correspond to a deleted record in transaction storage 326, but rather the transaction record of the deletion may persist as an abandoned order. In block 1716, the customer may continue shopping operations on the wireless device client until the customer indicates that shopping is complete.

Once shopping is complete, in block 1718, the wireless device client may be used to perform self-checkout. Note that the wireless device client may be used for non-self checkout scenarios as well as described in subsequent sections below. To perform checkout, in block 1720, the wireless device client will send a purchase list to the mobile electronic shopping server/fulfillment system 300; or alternatively the fulfillment system 300 will have maintained a virtual shopping cart for the client resident on the server. The mobile electronic shopping server/fulfillment system 300 will obtain final shopping cart cost totals, including but not limited to tax calculation operations, coupon discount calculations, and marketing special discounts. In block 1722, the wireless device client may be used to scan a checkout identifier which notifies the wireless device client that checkout is to be performed. The wireless device client may review purchase totals and related information prior to checkout. Upon the customer indicating assent via the wireless device client, in block 1724, the wireless device client will connect to the mobile electronic shopping server/fulfillment system 300 to complete checkout. Mobile electronic shopping server/fulfillment steps may include debiting the user's payment account, updating inventory, and archiving a transaction history to the user's mobile electronic shopping account. In block 1726, the mobile electronic shopping server/fulfillment system 300 may then cause a printer to print a receipt or otherwise may send an electronic receipt to the customer.

FIG. 18 provides an exemplary operation 1800 of a mobile electronic shopping server/fulfillment system 300. A mobile electronic shopping server/fulfillment system 300 may be associated with inventory data from a retail location, and accordingly is associated with a location identifier. Specifically, in block 1802, the fulfillment system 300 may interface with an inventory database via an inventory system interface. In this way, the mobile electronic shopping server/fulfillment system 300 need not be resident at a retail store or other vendor location. Once inventory data is determined to be associated with a location identified, in block 1804, the mobile electronic shopping server/fulfillment system 300, in block 1806, is ready to accept clients and create virtual shopping carts for that location.

When a client seeks to start shopping, in block 1808, the wireless device client will initialize a session with the mobile electronic shopping server/fulfillment system 300 via the wireless device client handshaking with the mobile electronic shopping server/fulfillment system 300. If a shopping cart is determined to exist, in block 1810, the mobile electronic shopping server/fulfillment system 300 will restore the shopping cart and its contents as session state, in block 1812. Otherwise, in block 1814, the mobile electronic shopping server/fulfillment system 300 will create a new virtual shopping cart. The session state may be comprised only of product identifier codes and quantities, and therefore the fulfillment system 300 may retrieve product data to associate with the product identifier codes. Upon doing so, the fulfillment system 300 will provide the shopping cart data to the client.

As the customer performs shopping operations, the wireless device client will make requests to retrieve product data for scanned items. This information is then provided, to the wireless device client on demand. Upon receiving wireless device client requests via messages to add or delete to indicate purchase decisions, the fulfillment system 300. If the customer chooses to order a product, in block 1820, the fulfillment system 300, will add items to the virtual shopping cart, in block 1822.

In block 1824, if the customer chooses to continue shopping, the flow proceeds to block 1826. The customer may then scan or otherwise enter another product identifier code in block 1828, where the product information process continues as described above. In some embodiments, the mobile electronic shopping server/fulfillment system 300 will maintain a continuous session. In other embodiments, the mobile electronic shopping server/fulfillment system 300 will be stateless, and may perform the cart acquisition process each time, as commencing in block 1810.

At any point, the customer may stop shopping. In this case, the fulfillment system 300 will store session state for future restoration.

When the customer indicates via the wireless device client indicates that shopping is complete, in block 1830, the checkout process may commence. The wireless device client, in block 1832, may initialize a connection with mobile electronic shopping server/fulfillment system 300. The fulfillment system 300 will receive an indication from the client. In block 1834, the wireless device client may send a purchase list, or alternatively the fulfillment system 300 will retrieve the purchase list from the virtual shopping cart resident on the server. The fulfillment system 300 will display the finalized totals, including, but not limited to tax calculation operations, coupon discount calculations, and marketing special discounts.

In block 1836, the customer may indicate whether to proceed with checkout. If the customer opts to continue shopping, work flow proceeds back to block 1824. Otherwise, upon receiving acceptance from the wireless device client, in block 1838, the wireless device client will reinitiate connection with the mobile electronic shopping server/fulfillment system 300, in block 1840, will receive a checkout location identifier, the fulfillment system 300 may conclude the transaction with operations including, but not limited to, debiting the customer payment account, updating inventory, and providing a paper or electronic receipt to the customer via the wireless device client in block 1842. The fulfillment system 300 will then close the transaction in block 1844 and will archive the transaction in transaction storage 326 and will associate with the user's mobile electronic shopping account in block 1846.

### Exemplary Additional Scenarios

Mobile electronic shopping is not limited to the scenarios described above. Most of the scenarios thus far described relate to self-checkout, that is the user scanning products, paying for products, and executing fulfillment with no or minimal aid from a store employee. Other variations include mobile shopping, that is a customer selecting items for purchase on-line, and then picking up and paying for the selected items when the customer goes to the store or fulfillment center.

Mobile electronic shopping enables additional business models. Some examples are enumerated as follows:
a. Loyalty Services: Since coupons may be provided to the wireless device, marketing revenue may be used cover mobile electronic shopping infrastructure expenses. For example, users of mobile electronic shopping may receive a coupon for a free latte, which encourages use of mobile electronic shopping, but also may be paid by the coffee company as part of an advertising campaign.
b. Online Fulfillment: When items are scanned during shopping, the user need not physically place the products in a physical cart. The user may notify the mobile electronic shopping server to deliver the products to a specific address. Example scenarios include online grocery shopping fulfillment and gift shipping to addresses other than that of the purchaser.
c. Shopper Data: Since the mobile electronic shopping servers store user transactions, the data may be aggregated for purposes of data mining. The data may be made available via a data mining portal. Alternatively, data sets may be packaged and distributed on demand.
d. Social Shopping: The wireless device may retrieve data beyond price and description data of products. For example the wireless device may retrieve user reviews, commentary and competitive pricing. The wireless device may retrieve social shopping lists, which contain lists of items to purchase, or endorsed by experts. For example, a snowboarding Olympic athlete may publish his shopping list of snowboarding equipment. By way of another example, the mobile electronic shopping servers may display lists of most popular or most purchased products.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system for performing mobile electronic shopping, the system comprising:
a wireless communications component configured to receive and transmit messages with one or more wireless devices of one or more customers of a local store;
an inventory system interface, to interface with an inventory system for the local store;
a checkout component, to debit payment accounts corresponding to the customers of the local store; and
a fulfillment component, communicatively coupled to the wireless communications component, the inventory system interface, and the checkout component, wherein the fulfillment component is to:
receive a first message from one of the one or more customers via the wireless communications interface, the first message including a scanned product identifier code,
retrieve product information via the inventory system interface, corresponding to the scanned product identifier code, and
debit a payment account via the checkout component, corresponding to the one of the one or more customers, upon receiving a purchase indicator in a second message from the one of the one or more customers, the second message received via the wireless communications interface.

2. The system of claim 1, further comprising a security component to register customers of the local store and to validate messages from customers of the local store, the fulfillment component communicatively coupled to the security component;
wherein the fulfillment component is to debit the payment account via the checkout component only if the second message is validated via the security component.

3. The system of claim 1, further comprising a profile component to store customer information, wherein the customer information includes a plurality of shipping addresses; and a shipping component to enter product orders to be delivered via mail, and the fulfillment component is communicatively coupled to the profile component and the shipping component;
wherein the purchase indicator in the second message is a gift ship
indicator; and the fulfillment component is to:
retrieve a shipping address corresponding to the customer of the local store, via the profile component;
enter an order to ship the product corresponding to the scanned product identifier code in the first message, via the shipping component.

4. The system of claim 3, wherein the fulfillment component is to:
obtain a shipping reference code via the shipping component; and
transmit the shipping reference code to the wireless device of the customer of the local store, via the wireless communications component.

5. The system of claim 1, further comprising a receipt component, the fulfillment component communicatively coupled to the receipt component, and the receipt component to:
generate a receipt via the receipt component upon the fulfillment component debiting the payment account via the checkout component, wherein the receipt corresponds to the debiting.

6. The system of claim 1, wherein the debit account of the customer of the local store is a payment account of electronic scrip.

7. The system of claim 1, wherein the inventory system interface is to interface with a cloud based inventory system for multiple local stores.

8. The system of claim 1, wherein the fulfillment component is integrated with any one of the following:
a point of sale system,
a sales kiosk,
a vending machine,
a restaurant electronic menu system, and
a signage driven billing system.

9. The system of claim 1, further comprising a transactional data storage, the fulfillment component communicatively coupled to the transactional data storage; and the fulfillment component configured to store a transaction record in the data transaction store, wherein the transaction record corresponds to the debiting.

10. The system of claim 9, further comprising a reporting component to generated reports for the local store, communicatively coupled to the transaction storage and the inventory system interface; the reporting component to generate reports including information on transactions performed by the fulfillment component.

11. The system of claim 10, wherein the generated reports are any one of:
a shopping order report;
a cart size report;
a purchase size report;
a duration of in-store stay report;
a favored items report report;
an abandoned items report report;
an act on coupon report report;
an act on discount report, and
an average transaction size report.

12. The system of claim 10, wherein the generated reports are generated according to any of the following:
in real time,
in batch, and
on demand.

13. The system of claim 10, further comprising a user interface component to receive report requests and to display report information, the reporting component communicatively coupled to the user interface component, and wherein the reporting component receives report requests and displays report information via the user interface component.

14. The system of claim 13, wherein the user interface component is remote, and the user interface component is integrated with any one of the following:
a dashboard application,
a mobile reporting application,
an email reporting system, and
a text messaging reporting system.

15. A method for performing mobile electronic shopping, the method comprising:
scanning a product identification code, by a wireless devices of a customer of a local store;
transmitting the scanned product identification code;
receiving information about a product corresponding to the product identification code from an inventory system of the local store, including product price information, responsive to the transmitting the scanned product identification code;
presenting the received information;
transmitting a purchase message including an indicator to purchase the product corresponding to the product information code; and
receiving a notification that the product corresponding to the product information code has been purchased, responsive to the transmitting the purchase message.

16. The method of claim 15, wherein the scanning is via near field communication.

17. The method of claim 16, wherein the near field communication scanning is any one of:
radio frequency identification (RFID), and
near field magnetic inductance (NFMI).

18. The method of claim 15, wherein the scanning is of a bar code containing supplemental information; and wherein the method further comprises presenting the supplement information from the bar code scan along with the retrieved information about the product corresponding to the product identification code.

19. The method of claim 18, wherein the bar code is a two dimensional code.

20. The method of claim 15, further comprising:
receiving supplemental information about a product corresponding to the product identification code from a third party information system, responsive to the transmitting the scanned product identification code; and
presenting the supplemental information from the bar code scan along with the retrieved information about the product corresponding to the product identification code.

21. The method of claim 20, wherein the supplemental information from the third party is any one of:
caloric information,
health alert information,
information of products with similar prices, and
third party product reviews.

22. A method to provide sales analytics, comprising:
receiving a plurality of purchase indicators of products, wherein the purchase indicators correspond to purchases of products scanned by wireless devices belonging to customers of a local store;
performing transactions corresponding to the purchase indicators, and storing transaction records corresponding to the transactions in a transaction storage;
retrieving from the transaction storage of transaction records, a set of transaction records, according to an analytics model;
performing an analysis of the retrieved set of transaction records according to the analytics model; and
presenting a report of the performed analysis to at least one customer corresponding to the retrieved set of transaction records.

23. The method of claim 22, wherein the analytics model, is a model to predict future purchases by the at least one customer.

24. The method of claim 22, wherein the set of transaction records corresponds to any one of the following:
a specific individual customer,
members of a family of a specific individual customer,
members of a social networking group that the specific individual customer belongs to, or
a predefined group of individuals that the specific individual customer belongs to.

25. The method of claim 22, further comprising:
determining via the analytic model whether a specific individual customer has satisfied a set of predetermined criteria to join a social networking group; and
when the specific individual customer has satisfies the set of predetermined criteria, automatically joining the specific individual customer to the social networking group.
